(19) United States
(12) Patent Application Publication
(10) Pub. No.: US 2023/0218469 A1
(43) Pub. Date: Jul. 13, 2023

(54) CURTAIN FOR A ROLLING WALKER

(71) Applicant: Valerie Gannaway, San Diego, CA (US)

(72) Inventors: Valerie Gannaway, San Diego, CA (US); Barbara J. Puccio, Stanley, NC (US)

(21) Appl. No.: 17/575,351

(22) Filed: Jan. 13, 2022

(51) Int. Cl. A61H 3/04

(52) U.S. Cl. CPC A61H 3/04; A61H 2201/0157; A61H 2201/0107; A61H 2201/0161; A61H 2003/002

(57) ABSTRACT

A curtain (20) for use by a user with a rolling walker (10) including a walker frame (12) having a front frame section (24) and a pair of opposed side frame sections (26) that are coupled to the front frame section (24), includes a curtain body (20A) and a coupling assembly (22). The curtain body (20A) is configured to wrap around the rolling walker (10) so that at least 75% of each of the front frame section (24) and the side frame sections (26) are covered by the curtain body (20A). The coupling assembly (22) is configured to couple the curtain body (20A) to the walker frame (12) of the rolling walker (10). The curtain body (20A) can be reversibly coupled to the walker frame (12). The coupling assembly (22) can include one or more coupling members (22A), wherein each of the one or more coupling members (22A) have at least one of a length and a position that is sufficient to accommodate frame members (12A) of the walker frame (12) having different circumferences.

### BACKGROUND

Certain health conditions, such as age-related physical conditions and/or physical conditions existing due to leg, hip or back injuries to name a few, can hinder balance and movement in the upright position or other mechanics of walking. The healthcare industry has developed ambulatory aids for those who suffer from such conditions, including crutches, wheelchairs, walkers, and rolling walkers, sometimes referred to as rollators.

Rolling walkers, or rollators, typically include a substantially U-shaped frame that creates a substantially U-shaped enclosure about the user, with three or four wheels being coupled to the frame; handlebars; and a built-in seat. The enclosure is open to the back and the user walks toward the closed front portion of the frame while using the lateral handlebars for support. The wheels are included in order to avoid the need to lift the device, and to facilitate its use as an ambulatory aid. The handlebars can be positioned near the top of the sides of the frame and provide a place for the user to place their hands during use and control of the rolling walker. The handlebars can also include and/or incorporate hand brakes that can be lifted up or pushed downward to selectively activate a braking mechanism that engages the wheels to instantly stop the rolling walker. The braking mechanism can also be used in maneuvering the rolling walker, such as by braking one side while turning the rolling walker towards that side so that a much tighter turning radius can be achieved. The built-in seat provides the user with a place to sit and rest when that need arises (for example, when the user needs a break from standing or walking). When using the built-in seat, the user turns to face the open side and sits facing the opposite direction from the orientation when the support is in active ambulatory use.

There is a continuing desire to provide advancements for the rolling walkers to make rolling walkers more useful for the user, as well as more aesthetically pleasing for the user.

### SUMMARY

The present invention is directed toward a curtain for use by a user with a rolling walker, the rolling walker including a walker frame having a front frame section and a pair of opposed side frame sections that are coupled to the front frame section. In various embodiments, the curtain includes a curtain body and a coupling assembly. The curtain body is configured to wrap around the rolling walker so that at least 75% of each of the front frame section and the side frame sections are covered by the curtain body. The coupling assembly is configured to couple the curtain body to the walker frame of the rolling walker.

In some embodiments, the curtain body is configured to wrap around the rolling walker so that at least 90% of each of the front frame section and the side frame sections are covered by the curtain body.

In certain embodiments, the coupling assembly is configured to removably couple the curtain body to the walker frame of the rolling walker.

In some embodiments, the curtain body includes a first surface having a first design and an opposed second surface having a second design that is different than the first design. Alternatively, the first design and the second design can be the same.

In various embodiments, the curtain body can be reversibly coupled to the walker frame so that in a first configuration the first surface faces in an outwardly direction away from the walker frame, and in a second configuration the second surface faces in an outwardly direction away from the walker frame.

In certain embodiments, the walker frame includes a plurality of frame members. In such embodiments, the coupling assembly includes one or more coupling members that are configured to couple the curtain body to the walker frame of the rolling walker.

In various embodiments, each of the one or more coupling members can have at least one of a length and a position that is sufficient to accommodate the frame members of the walker frame having different circumferences.

In some embodiments, the curtain body is formed as a unitary structure.

In certain embodiments, the rolling walker is movable between an active configuration and a folded configuration.

In various embodiments, the coupling assembly can be configured such that the curtain body remains coupled to the walker frame during movement of the rolling walker between the active configuration and the folded configuration.

In some embodiments, the curtain further includes one or more pockets that are coupled to the curtain body.

In certain embodiments, at least one of the one or more pockets can be transparent. Additionally, or in the alternative, at least one of the one or more pockets can be selectively closeable with a closing mechanism, such as elastic closures, magnets, snaps, hook and loop material, zippers, etc.

The present invention is also directed toward a curtain for use by a user with a rolling walker, the rolling walker including a walker frame having a plurality of frame members, and a plurality of wheels that are coupled to the walker frame, the curtain including a curtain body; and a coupling assembly including one or more coupling members that are configured to couple the curtain body to the walker frame of the rolling walker, each of the one or more coupling members having at least one of a length and a position that is sufficient to accommodate the frame members of the walker frame having different circumferences.

The present invention is also directed toward a curtain for use by a user with a rolling walker, the rolling walker including a walker frame, the rolling walker being movable between an active configuration and a folded configuration, the curtain including a curtain body; and a coupling assembly that is configured to couple the curtain body to the walker frame of the rolling walker, the coupling assembly being configured such that the curtain body remains coupled to the walker frame during movement of the rolling walker between the active configuration and the folded configuration.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a top perspective front view illustration of a rolling walker including a walker frame and an embodiment of a curtain for the rolling walker having features of the present invention that is coupled to the walker frame;

FIG. 1B is a top perspective rear view illustration of the rolling walker and the curtain illustrated in FIG. 1A;

FIG. 1C is a front elevation view illustration of the rolling walker and the curtain illustrated in FIG. 1A;

FIG. 1D is a rear elevation view illustration of the rolling walker and the curtain illustrated in FIG. 1A;

FIG. 1E is a side elevation view illustration of the rolling walker and the curtain illustrated in FIG. 1A;

FIG. 1F is a top view illustration of the rolling walker and the curtain illustrated in FIG. 1A;

FIG. 2A is a top perspective front view illustration of the rolling walker and the curtain illustrated in FIG. 1A, with the curtain shown in a first position;

FIG. 2B is a top perspective front view illustration of the rolling walker and the curtain illustrated in FIG. 1A, with the curtain shown in a second position that is different than the first position;

FIG. 3A is a top perspective front view illustration of the rolling walker and the curtain illustrated in FIG. 1A, with the rolling walker and the curtain in an active configuration;

FIG. 3B is a top perspective front view illustration of the rolling walker and the curtain illustrated in FIG. 3A, with the rolling walker and the curtain in a folded configuration;

FIG. 4A is a top perspective front view illustration of another embodiment of the rolling walker and the curtain, with the rolling walker and the curtain in the active configuration; and

FIG. 4B is a top perspective front view illustration of the rolling walker and the curtain illustrated in FIG. 4A, with the rolling walker and the curtain in the folded configuration.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DESCRIPTION

Embodiments of the present invention are described herein in the context of a curtain for a rolling walker (also sometimes referred to herein simply as a “walker”) having a unique design that provides various advantages to the user of the rolling walker. For example, in various embodiments, the curtain for the rolling walker as described in detail herein can include advantages such as (1) the curtain wraps around a walker frame (also referred to herein simply as a “frame”) of the walker so that a substantial percentage of the area defined by the frame is covered on three sides to provide enhanced privacy, security and protection (such as from breezes and/or splashing water) for the user of the walker; (2) the curtain can be reversible, and can potentially have different characteristics, patterns and/or customizations on each side of the curtain (such as waterproof on one side, different number of pockets on each side, different design or themed patterns on each side, etc.); (3) any pockets that may be coupled to the curtain can be transparent (such as with a mesh design) so that items placed within the pockets are easily visible to the user of the walker; (4) any pockets that may be coupled to the curtain can be selectively closable and/or sealable via any suitable closing mechanisms (such as elastic closures, magnets, snaps, hook and loop material, zippers, etc.); (5) the curtain is easily removable from the frame so that the curtain can be easily washed as needed, and/or so that the user can wrap the curtain around themselves (their legs and/or their bodies) for potential use as a warming cover or wrap; (6) the curtain can be formed as a unitary structure; (7) a coupling assembly for selectively coupling the curtain to the frame can include one or more coupling members that can loop around one or more portions of the frame of the walker and secure the curtain to itself (e.g., hook and loop material (or other appropriate attachment means such as ties, snaps, buttons, etc.) can be secured to a portion of the curtain, not to the frame of the walker); (8) a length and/or width of the curtain can be adjustable relative to the frame and/or to the individual rolling walker such that the curtain can be used on walkers of different sizes and/or of different designs; (9) the coupling assembly and/or the coupling members can be adjustable relative to the frame such that the curtain relative to the wheels and/or the surface on which the walker is being used can be selectively adjusted; (10) the coupling members can be provided of sufficient length or size, and/or the coupling members can be positioned in an appropriate manner, such that the coupling assembly and/or the coupling members can be used with frames where the frame members can have different circumferences (the coupling members can effectively wrap around frame members with small circumferences and frame members with large circumferences) to effectively couple the curtain to the frame of the walker; (11) the curtain can remain coupled to the frame while the walker is moved between an active (open) configuration and a folded (closed) configuration; (12) the curtain and/or the coupling assembly can include a main strap portion (which can be formed from leather, faux leather, vinyl, cut and loop, etc. in certain non-exclusive embodiments) that some of the curtain coupling members and the cover portion of the curtain are attached to; and/or (13) the curtain can function to control and/or restrict the positioning of brake wires of a braking system incorporated into the walker so that the braking wires are inhibited from catching on external devices (such as door knobs, etc.).

Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same or similar reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it is appreciated that such a development effort might be complex and time-consuming, but would nevertheless be a routine undertaking of engineering for those of ordinary skill in the art having the benefit of this disclosure.

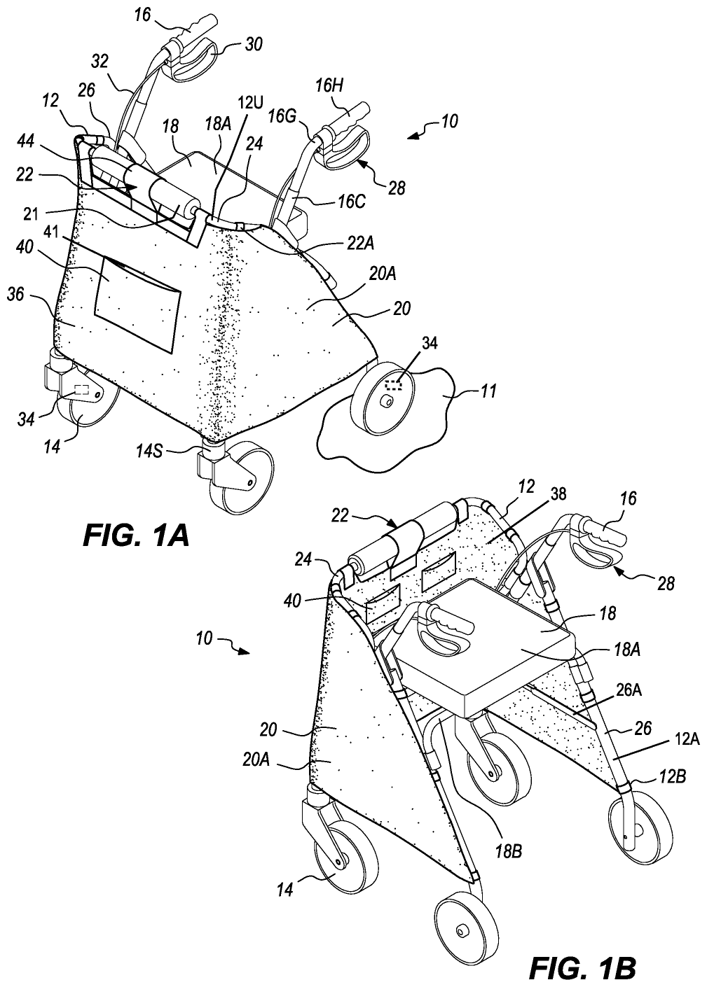

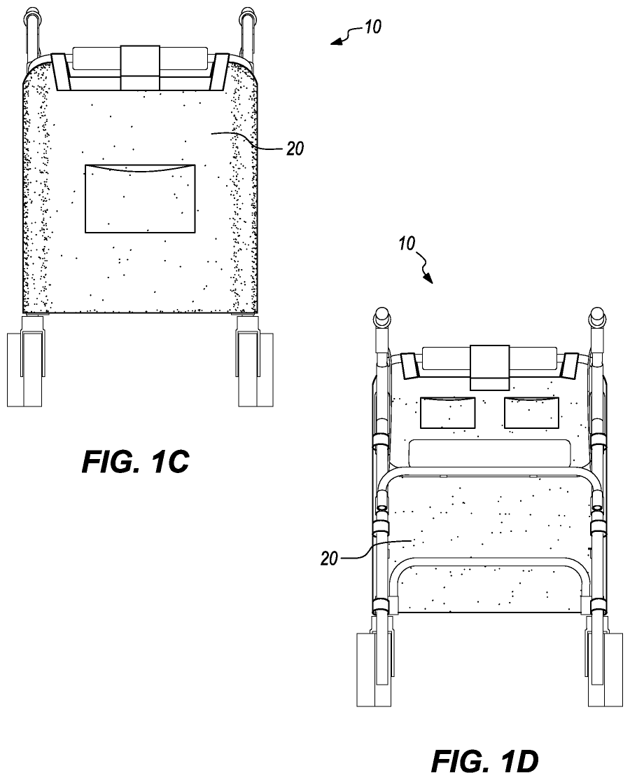

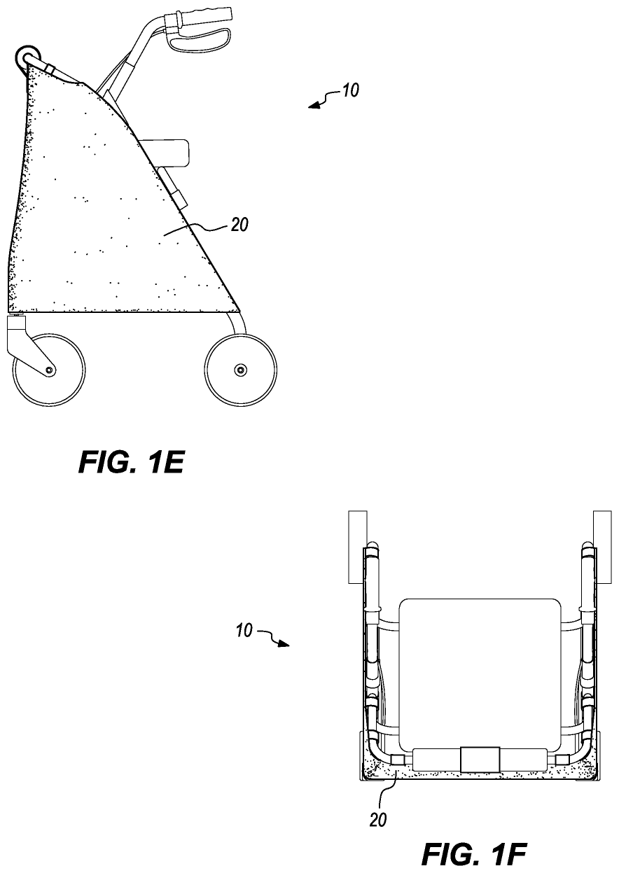

FIG. 1A is a top perspective front view illustration of a rolling walker 10 (also sometimes referred to herein simply as a “walker”) that is usable by a user as an ambulatory aid relative to a surface 11, such as a road, a sidewalk or a floor. In various embodiments, the walker 10 can include one or more of a walker frame 12 (also sometimes referred to herein simply as a “frame”), a plurality of wheels 14 that are coupled to the frame 12, a pair of handlebars 16, a seat 18, and an embodiment of a curtain 20 for the rolling walker 10 having features of the present invention that is coupled to the walker frame 12. Also visible in FIG. 1A is at least a portion of a coupling assembly 22 that is usable for selectively coupling the curtain 20 to the frame 12 of the rolling walker 10. Additionally, or in the alternative, the rolling walker 10 can include more components or fewer components than what is specifically illustrated and described herein. For example, in some embodiments, the walker 10 can further include a back support 21 that provides a surface which the user can lean against when positioned on the seat 18.

The frame 12 can have any suitable design. As illustrated in FIG. 1A, the frame 12 can include a front frame section 24 that has an overall configuration that is substantially rectangular-shaped, and a pair of opposed side frame sections 26 (also more clearly visible in FIG. 1B) that are coupled to the front frame section 24, with each side frame section 26 having an overall configuration that is substantially triangular-shaped. In one embodiment, each of the side frame sections 26 are coupled to the front frame section 24 at an angle of approximately ninety degrees so as to form an overall frame 12 that is substantially U-shaped to provide a substantially U-shaped enclosure for the user. Alternatively, the frame 12 and/or the component frame sections 24, 26 can have another suitable design. For example, in one non-exclusive alternative embodiment, the front frame section 24 can include a portion that is substantially U-shaped that extends in a generally upward direction from an upper portion 12U of the front frame section 24.

The frame 12 can be formed from any suitable materials. For example, in one non-exclusive embodiment, the frame 12 is formed from a plurality of hollow tubular steel or aluminum frame members 12A (illustrated more clearly in FIG. 1B) that are coupled and/or secured together to form the frame 12. Alternatively, the frame 12 can be formed from different materials, such as other suitable metal or plastic materials, and/or be manufactured or assembled in another suitable manner. It is appreciated that in different embodiments, the frame 12 can include frame members 12A that have different circumferences.

The wheels 14 are coupled to the frame 12 and are configured to enable the user to easily move the walker 10 along the surface 11, such as a road, a sidewalk or a floor. The walker 10 can include any suitable number of wheels 14 that can be coupled to the frame 12 in any suitable manner. As illustrated in FIG. 1A, in one embodiment, the walker 10 includes four wheels 14, with each of the wheels 14 being coupled to the frame 12 near a bottom 12B (illustrated in FIG. 1B) of the frame 12. More particularly, in this embodiment, a separate wheel 14 is coupled to the bottom 12B of the frame 12 at each lower corner of the frame 12 such that the walker 10 effectively includes two front wheels 14, i.e. at the bottom 12B of the frame 12 at corners where the front frame section 24 is coupled to each of the side frame sections 16, and two rear wheels 14, i.e. at the bottom 12B of the frame 12 at corners of each side frame section 26 away from the front frame section 24. In one such embodiment, each of the front wheels 14 can be a caster-type wheel that is rotatable so that the user can steer the walker 10 as desired; and each of the rear wheels 14 can be fixed in orientation relative to the frame 12 to follow the front wheels 14 in a generally straight forward manner (and not to provide any steering of the walker 10 with the rear wheels 14). Alternatively, all four of the wheels 14 can be caster-type wheels 14, or the rear wheels 14 can be caster-type wheels and the front wheels 14 can be fixed in orientation relative to the frame 12 so as to not provide any steering of the walker 10. Still alternatively, the wheels 14 can have another suitable design.

The wheels 14 can be formed of one or more suitable materials. In one non-exclusive embodiment, each of the wheels 14 can include an inflated tire. In other embodiments, the wheels 14 can include a solid material such as a suitable rubber or plastic material. Alternatively, the wheels 14 can have another suitable design.

In some embodiments, the frame 12 can be adjustable in height relative to the wheels 14. More specifically, in such embodiments, the means of coupling the wheels 14 to the frame 12 can be adjustable so as to selectively adjust a height of the frame 12 relative to the surface 11 so as to more effectively and comfortably suit the user of the walker 10. In one such embodiment, each of the wheels 14 can include a wheel shaft 14S that can be coupled to the frame 12 in a telescoping manner. In such embodiment, one of the wheel shaft 14S and the frame 12 can include a detent button (not shown) and the other of the wheel shaft 14S and the frame 12 can include a plurality of spaced apart apertures (not shown) that are configured to selectively receive the detent button. With such design, the frame 12 can be positioned at a plurality of alternative, discrete individual settings relative to the wheels 14 and/or the surface 11. Alternatively, the means of coupling the wheels 14 to the frame 12 can have another suitable design to enable the selective adjusting of the height of the frame 12 relative to the wheels 14 and/or the surface 11. Still alternatively, the frame 12 need not be adjustable in height relative to the wheels 14 and/or the surface 11.

The handlebars 16 are configured to be easily grasped by the user during use of the walker 10 to aid the user in balance and control of the walker 10. The design of the handlebars 16 can be varied to suit the comfort of the user. As shown in this embodiment, each of the handlebars 16 includes a coupling portion 16C that is coupled to the corresponding side frame section 26 and extends upwardly at an angle from the corresponding side frame section 26; and a gripping portion 16G that extends away from the coupling portion 16C such that at least a portion of the gripping portion 16G is substantially parallel with the surface 11 (within approximately five degrees) upon which the walker 10 is being used. The gripping portion 16G can further include a handle grip 16H that can easily and comfortably be gripped by the user. Alternatively, in other embodiments, the handlebars 16 can have another suitable design.

In certain embodiments, the handlebars 16 can be adjustable in height relative to the frame 12 and/or extension of the gripping portion 16G away from the coupling portion 16C to better suit the comfort of the individual user of the walker 10. It is appreciated that such adjustability can be accomplished in any suitable manner. Alternatively, in other embodiments, the handlebars 16 can be fixed in position relative to the frame 12.

In various embodiments, as shown in FIG. 1A, there is a braking system 28 that can be coupled, at least in part, to the handlebars 16. The braking system 28 is configured to enable the user to selectively and quickly stop movement of the walker 10 along the surface 11. In alternative embodiments, the braking system 28 can be coupled to one or more of the wheels 14 of the walker 10, including the rear wheels 14 and/or the front wheels 14, and preferably to at least one wheel 14 on each side of the walker 10 so that movement of the walker 10 can be stopped consistently on either or both sides of the walker 10.

The design of the braking system 28 can be varied. In certain embodiments, on each side of the walker 10, the braking system 28 can include a brake lever 30 coupled to the handlebar 16 near the handle grip 16H, a brake wire 32 that is coupled to the brake lever 30, and a braking mechanism 34 (illustrated in phantom in relation to one of the front wheels 14 and one of the rear wheels 14, although it is understood that such braking mechanism 34 can be used in relation to any or all of the wheels 14), such as a brake pad or a brake shoe, that is coupled to the brake wire 32. During use of the braking system 28, the user can squeeze the brake lever 30 so that the brake lever 30 moves toward the handlebar 16 and/or the handle grip 16H, which in turn pulls on the brake wire 32 which selectively activates the braking mechanism 34 so that the braking mechanism 34 moves toward and contacts the wheel(s) 14 to which the braking mechanism 34 is coupled. The contact between the braking mechanism 34 and the corresponding wheel(s) 14 inhibits continued rotation of the wheel(s) 14 thereby slowing and/or stopping movement of the walker 10 along the surface 11. Alternatively, the braking system 28 can have another suitable design and/or one or more components of the braking system 28 can be positioned in a different manner than what is shown in FIG. 1A.

In some embodiments, the braking system 28 can additionally be used as a parking brake that can be selectively activated to maintain a desired position of the walker 10 relative to the surface 11. For example, in one such embodiment, moving the brake lever 30 away from the handlebar 16 can activate a parking brake mechanism (not shown) to move against one or more of the wheels 14 to stop movement of the walker 10 along the surface 11.

The seat 18 is coupled to the frame 12 and is configured to provide the user with a place to sit and rest when desired, such as when the user needs a break from standing or walking. The seat 18 can have any suitable design that is configured to fully support the weight of the user, as desired, relative to the frame 12. In some embodiments, the seat 18 can include a molded plastic seating member 18A upon which the user can sit, and which is coupled to the frame 12 with one or more seat support members 18B (illustrated in FIG. 1B). Alternatively, the seat 18 can have another suitable design.

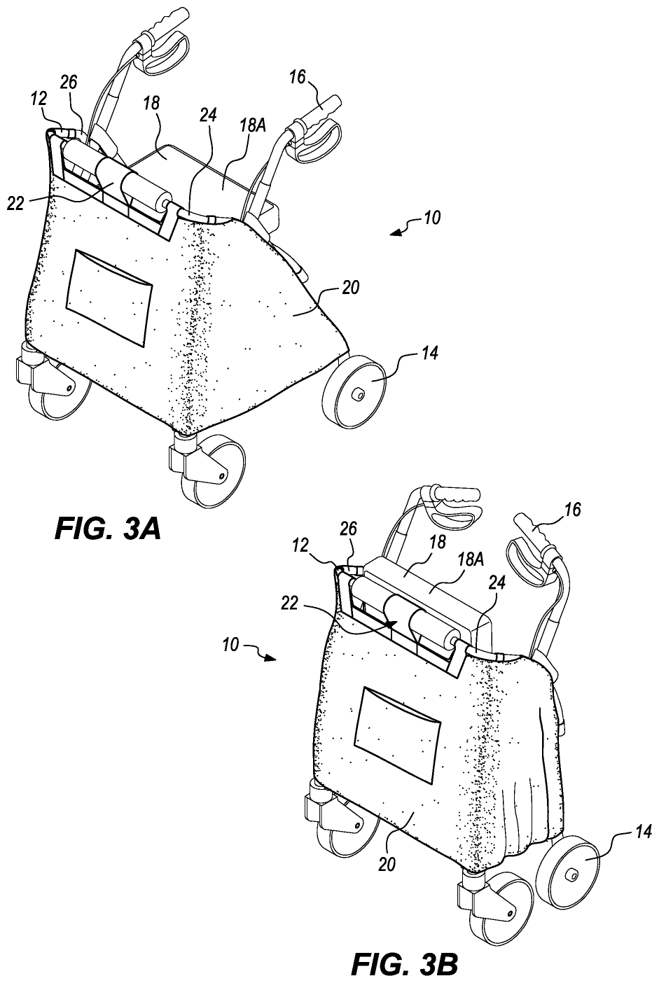

In certain embodiments, the seat support members 18B can be movably coupled to the frame 12 so that the seat 18 is selectively movable between a deployed configuration (such as illustrated in FIG. 1A) where the seating member 18A can be actively used by the user, and a folded configuration (such as illustrated in FIG. 3B) where the seating member 18A is folded toward the frame 12, such as toward the front frame section 24, so that the seating member 18A does not get in the way of or otherwise impede the user during use of the walker 10. For example, in one such embodiment, the seat support members 18B can be pivotably coupled to the frame 12 such that the seating member 18A can pivot in a generally upward and forward direction so that when the seat 18 is in the folded configuration the seating member 18A is positioned substantially adjacent to and parallel with the front frame section 24. Moving the seating member 18A to a vertically-collapsed state as described above, in some embodiments, can open up a space that will permit the user to move forwardly within the frame 12 of the walker 10. However, in other embodiments, at least one of the seat support members 18B can be fixedly coupled to the frame 12 so that moving the seating member 18A to the vertically-collapsed state does not necessarily open up such space within the frame 12 for the user.

In some such embodiments, the walker 10 can further include a seat locking mechanism (not shown) so that the seat 18 can be locked in the folded configuration. The seat locking mechanism can be provided to ensure that the seat 18 does not move from the folded configuration to the deployed configuration when such movement is not desired by the user. A seat release mechanism (not shown) can further be included to release the seat 18 from the folded configuration when the user desires to move the seat 18 from the folded configuration to the deployed configuration.

In some embodiments, as shown, the walker 10 can further include the back support 21 against which the user can lean when using the seat 18. In one such embodiment, the back support 21 can be formed as a generally cylindrical-shaped padded material that can fit around a portion of the frame 12. Alternatively, the back support 21 can have another suitable design and/or shape. For example, in some non-exclusive alternative embodiments, the frame 12 can include a somewhat U-shaped portion within the front frame section 24, and the back support 21 can then be designed to have a corresponding U-shaped design that can be fitted about the U-shaped portion of the front frame section 24.

As further described, in various embodiments, the walker 10 can be selectively movable and/or foldable between an active (open) configuration and a folded (closed) configuration. It is appreciated that the movement between the active configuration and the folded configuration can be accomplished in any suitable manner. It is merely appreciated that when the walker 10 is in the active configuration, the walker 10 is ready for use by the user, and when the walker 10 is in the folded configuration, the walker 10 requires much less space for transport or storage.

In certain such embodiments, such as illustrated in FIGS. 3A and 3B, the seat 18 can be pivotably and/or movably coupled to the frame 12, and the side frame sections 26 can include a frame design that is selectively collapsible. More particularly, in such embodiments, during movement from the active configuration to the folded configuration, the seat 18 can be pivoted and/or moved relative to the frame 12 such as in the manner described above so that the seating member 18A is positioned substantially adjacent to and parallel with the front frame section 24. Additionally, during movement from the active configuration to the folded configuration, each of the side frame sections 26 can be collapsed inwardly upon themselves so that the rear wheels 14 on each side of the frame 12 are moved to be positioned substantially adjacent to the front wheels 14 on the same, corresponding side of the frame 12 when the walker 10 is in the folded configuration. In some such embodiments, it is appreciated that only certain portions of the side frame sections 26, such as a lower frame linkage 26A (illustrated in FIG. 1B) of the side frame section 26, may be collapsible during movement between the active configuration and the folded configuration.

In such embodiments, the handlebars 16 can also be rotatably coupled to the frame 12. For example, in one such embodiment, during movement from the active configuration to the folded configuration, the handlebars 16 can be rotated and/or pivoted relative to the frame 12 by approximately ninety degrees so that the handlebars 16 face toward one another and are also substantially parallel to the front frame section 24 and the seating member 18A. With such design, the walker 10 can have an even flatter overall configuration in the folded configuration for further space savings for purposes of storage and/or transport. The steps can then be reversed when it is desired to move the walker 10 from the folded configuration back to the active configuration.

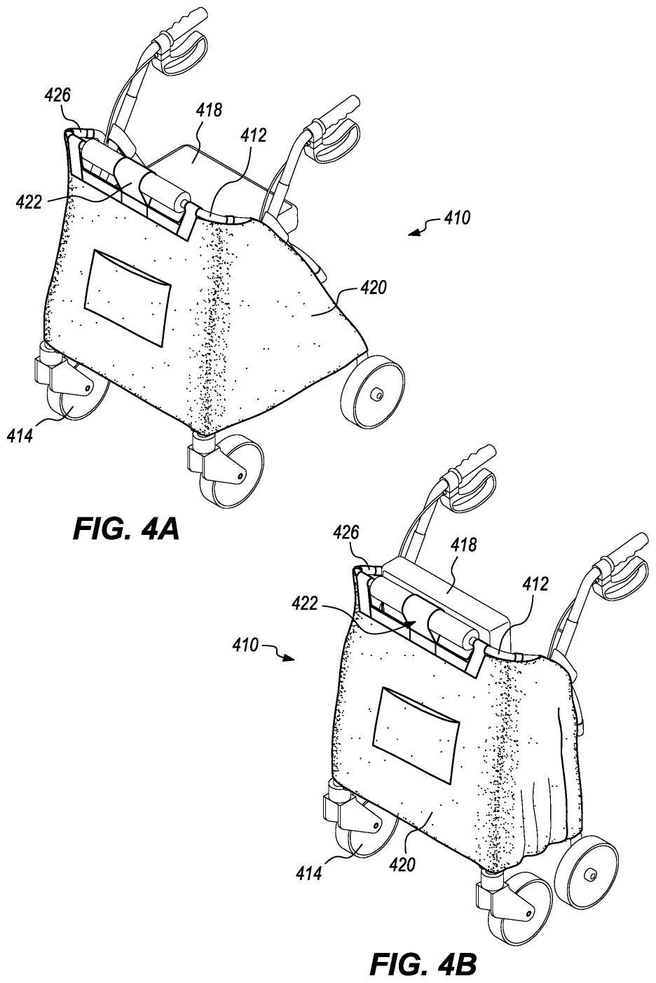

Alternatively, movement of the walker 10 between the active configuration and the folded configuration can be accomplished in another suitable manner. For example, in one non-exclusive alternative embodiment, such as illustrated in FIGS. 4A and 4B, during movement from the active configuration to the folded configuration, the seat 418 can be pivotably and/or movably coupled to the frame 412 in a manner similar to that described above. Additionally, in such embodiment, similar to above, the side frame sections 426 can include a frame design that is selectively collapsible, such that each of the side frame sections 426 can be collapsed inwardly upon themselves so that the rear wheels 414 on each side of the frame 412 are moved to be positioned substantially adjacent to the front wheels 414 on the same, corresponding side of the frame 412 when the walker 410 is in the folded configuration. However, in this embodiment, the handlebars 416 are not rotated relative to the frame 412.

In another non-exclusive alternative embodiment, the seating member 18A itself can be formed from a foldable material (or the seat 18 can be pivotable to one side or the other), and the front frame section 24 can include a frame design that is selectively collapsible. In such embodiment, the seating member 18A can be pulled upwardly and/or pushed downwardly to be folded roughly in half (or pivoted toward one side or the other), and at the same time the front frame section 24 can be collapsed inwardly upon itself so that the front wheels 14 are positioned substantially adjacent to one another, and the rear wheels 14 are also positioned substantially adjacent to one another, when the walker 10 is in the folded configuration.

In still another non-exclusive alternative embodiment, the side frame sections 26 can be pivotably and/or movably coupled to the front frame section 24, as well as the seat 18 being pivotably and/or movably coupled to the frame 12. More particularly, in such embodiment, each of the seat 18 and the side frame sections 26 may be selectively movable from a first (active) position to a second (folded) position. For example, during movement from the active configuration to the folded configuration, the seat 18 can be pivoted and/or moved relative to the frame 12 such as in the manner described above so that the seating member 18A is positioned substantially adjacent to and parallel with the front frame section 24. Subsequently, each of the side frame sections 26 can then be pivoted in turn relative to the front frame section 24 so that each of the side frame sections 26 is substantially parallel to the front frame section 24 and the seating member 18A.

The curtain 20 includes a curtain body 20A that is selectively, adjustably and/or removably coupled to the frame 12 of the walker 10 in a manner so as to provide certain advantages, protections and privacies for the user of the walker 10. The design of the curtain 20 can be varied.

In a first advantage of the present invention, in some embodiments, the curtain 20 can be configured to provide enhanced privacy, security and/or protection for the user of the walker 10. In certain uses, the curtain 20 can provide privacy and/or security by hiding from public view any personal items which the user may have retained within pockets, baskets, etc. that may be included with the curtain 20 and/or the walker 10. The curtain 20 can also provide protection to the user, primarily from the waist to the lower extremities, from breezes and/or splashing water (such as from puddles). In such embodiments, the curtain 20 and/or the curtain body 20A can be sized and shaped to wrap around a substantial portion of the frame 12, including a substantial portion of the front frame section 24 and each of the side frame sections 26. In some non-exclusive alternative embodiments, the curtain 20 and/or the curtain body 20A can be configured to cover at least approximately 50%, 55%, 60%, 65%, 70%, 75%, 80%, 85%, 90% or 95% of the frame 12. In one such embodiment, the curtain 20 and/or the curtain body 20A can be configured to cover at least approximately 50%, 55%, 60%, 65%, 70%, 75%, 80%, 85%, 90% or 95% of each of the front frame section 24 and each of the side frame sections 26 of the frame 12. Alternatively, the curtain 20 and/or the curtain body 20A can be configured to cover a different percentage of the frame 12 than the numbers specifically noted above. Still alternatively, in other embodiments, the curtain 20 and/or the curtain body 20A can be configured to cover only the front frame section 24 and/or only limited portions of the side frame sections 26.

In another advantage of the present invention, in certain embodiments, the curtain 20 can be reversible relative to the frame 12 of the walker 10, having different characteristics, patterns and/or customizations on each side of the curtain body 20A. For example, in one implementation, the curtain 20 can have a first design on a first surface 36 of the curtain body 20A (such as an outer surface of the curtain body 20A as shown in FIG. 1A) and can have a second design on a second surface 38 of the curtain body 20A (such as an inner surface of the curtain body 20A as shown in FIG. 1B) that is different than the first design. Subsequently, the position of the curtain 20 relative to the frame 12 can be reversed such that the first design is on the inner surface of the curtain body 20A, and the second design is on the outer surface of the curtain body 20A.

It is appreciated that the designs on the first surface 36 and the second surface 38 of the curtain body 20A can be varied as desired. For example, in certain implementations, the different designs can include being waterproof on one side and not the other, having a different number of pockets on each side, having different design patterns on each side, etc. In other implementations, the curtain body 20A can have different themed designs on either surface 36, 38 that can be alternatively displayed to the public. For example, in some non-exclusive alternative implementations, the themed designs can include flags, holiday designs, sports-related themes, animal designs, and/or any other themed designs to make a desired statement or to potentially create pleasant engagement from others in the community.

It is appreciated, however, that in other embodiments, the curtain body 20A can have the same design on each of the first surface 36 and the second surface 38.

In some embodiments, the curtain 20 and/or the curtain body 20A can include one or more pockets 40 on the first surface 36 and/or the second surface 38 of the curtain body 20A that are usable for the user to store any of various personal items. As shown in FIG. 1A, the first surface 36 includes one pocket 40 and the second surface 38 includes two pockets 40. Alternatively, the first surface 36 and/or the second surface 38 can include a different number of pockets 40.

It is appreciated that the pockets 40 can be of any suitable size and shape so long as there is ample space along the surface 36, 38 of the curtain body 20A. The pockets 40 can be used for storing any desired personal items of the user. For example, the pockets 40 can be used for storing personal items such as a purse, wallet, keys, medication, binoculars, reading glasses, a water bottle, food or drink, a cellular telephone, tracking devices, a portable computer, a hat, clothing, small tools, etc.

In some embodiments, the pockets 40 can be closeable and/or sealable to better protect the personal items that may be retained therein. For example, in certain such embodiments, one or more of the pockets 40 can include a closing mechanism 41 that is usable to close and/or seal the pockets 40 so that any personal items retained therein are better protected. In some non-exclusive such embodiments, the closing mechanism 41 can include one or more of elastic closures, magnets, snaps, zippers, hook and loop material, etc.

It is also appreciated that in some embodiments, the walker 10 may further include a bag, a basket, or other suitable storage device (not shown) that may be mounted underneath the seat 18, and which can be used to store some of the larger personal items of the user, such as binoculars, portable computer, clothing, etc.

In still another advantage of the present invention, in certain embodiments, any of the pockets 40 that may be coupled to the curtain body 20A can be transparent (such as with a mesh design) so that items placed within the pockets 40 are easily visible to the user of the walker 10.

In another advantage of the present invention, it is further appreciated that as part of being reversible, the curtain 20 is also selectively removable from the frame 12. With such design, the curtain 20 can be easily removed from the frame 12 so that the curtain 20 can easily be washed as needed. Thus, it is understood that in such embodiments, the curtain 20 can be made from a material that is washable. In certain implementations, the curtain 20 and/or the curtain body 20B can be formed from quilting cotton material, wool, fleece, polyester, denim, etc. In any such implementations, it is appreciated that the specific materials chosen for the curtain 20 can be chosen so as to specifically block the breeze and/or to effectively function as a splash guard, or can be chosen to allow at least a portion of the breeze to pass therethrough. It is further appreciated that the specific materials chosen for the curtain 20 can be based on what materials may be more suited for potential use as a warming cover or wrap. However, it is further understood that the curtain 20 can be formed from any suitable materials.

In some embodiments, the curtain 20 and/or the curtain body 20A can include different materials toward a bottom of the curtain body 20A so that the curtain 20 can be more effectively weighted down. For example, in one non-exclusive embodiment, the bottom of the curtain body 20A can include a heavier weighted material than other portions of the curtain body 20A, such as a heavy vinyl material or other suitable heavier weighted material. In another non-exclusive embodiment, one or more weights can be sewn into or otherwise coupled into the bottom of the curtain body 20A so that the curtain 20 can be more effectively weighted down.

In yet another advantage of the present invention, in certain embodiments, the curtain 20 and/or the curtain body 20A can be formed as a unitary (one-piece) structure. Stated in another manner, in such embodiments, the curtain 20 and/or the curtain body 20A can be formed from multiple pieces of material, including at least one piece of material that provides the first surface 36, and another piece of material that provides the second surface 38, which are bound together in any suitable manner. It is appreciated that one or more additional pieces of material can be included between the piece of material (or padding) that provides the first surface 36 and the piece of material that provides the second surface 38. With such design, the unitary (bound, one-piece) structure enables the user to couple the curtain 20 to the frame 12 and remove the curtain 20 from the frame 12 as a single structural entity. Alternatively, the curtain 20 and/or the curtain body 20A can have another suitable design.

In various embodiments, the coupling assembly 22 is configured to selectively, adjustably and/or removably couple the curtain 20 to the frame 12 of the walker 10. The coupling assembly 22 can have any suitable design for purposes of effectively coupling the curtain 20 to the frame 12 of the walker 10.

As illustrated, in certain embodiments, the coupling assembly 22 can include a plurality of coupling members 22A that are secured to the curtain 20 and that are configured to wrap around a portion of the frame 12 of the walker 10. In some such embodiments, the coupling assembly 22 for selectively coupling the curtain 20 to the frame 12 can include one or more coupling members 22A that can loop around one or more portions of the frame 12 of the walker 10, and/or around a portion of the back support 21, and secure the curtain 20 to itself. For example, hook and loop material can be secured to a portion of the curtain body 20A and not to the frame 12 of the walker 10. Alternatively, the coupling members 22A can be coupled to themselves and/or the curtain body 20A using other suitable attachment means such as ties, snaps, buttons, etc.). Still alternatively, in other embodiments, one or more of the coupling members 22A can be secured to the frame 12.

In another advantage of the present invention, in some embodiments, a length and/or a width of the curtain 20 can be adjustable relative to the frame 12 and/or to the individual walker 10 upon which the curtain 20 is being used.

In still another advantage of the present invention, in some embodiments, the coupling assembly 22 and/or the coupling members 22A can be adjustable relative to the frame 12 such that a height of the curtain 20 relative to the frame 12 or the wheels 14 of the walker 10 and/or the surface 11 on which the walker 10 is being used can be selectively adjusted.

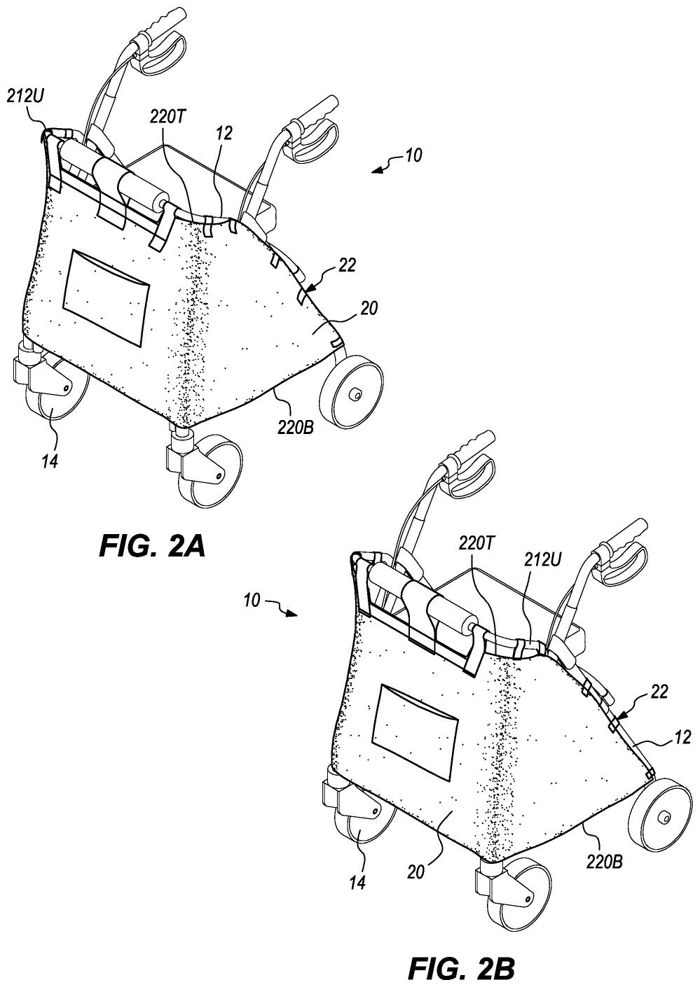

Referring now to FIGS. 2A and 2B, FIG. 2A is a top perspective front view illustration of the rolling walker 10 and the curtain 20 illustrated in FIG. 1A, with the curtain 20 shown in a first position; and FIG. 2B is a top perspective front view illustration of the rolling walker 10 and the curtain 20 illustrated in FIG. 1A, with the curtain 20 shown in a second position that is different than the first position. More specifically, in FIG. 2A, with the curtain 20 at the first position, the curtain 20 is coupled to the frame 12 of the walker 10, i.e. with the coupling assembly 22, such that a top portion 220T of the curtain 20 is substantially directly adjacent to an upper portion 212U of the frame 12, and such that a bottom portion 220B of the curtain 20 is somewhat spaced apart from the wheels 14 of the walker 10. However, in FIG. 2B, with the curtain 20 in the second position, the curtain 20 is coupled to the frame 12 of the walker 10, i.e. with the coupling assembly 22, such that the top portion 220T of the curtain 20 is somewhat spaced apart from the upper portion 212U of the frame 12, and such that the bottom portion 220B of the curtain 20 is substantially directly adjacent to the wheels 14 of the walker 10.

It is appreciated, however, that the adjustability of height of the curtain 20 relative to the frame 12 or wheels 14 of the walker 10 and/or relative to the surface 11 (illustrated in FIG. 1) upon which the walker 10 is being used does not require that the curtain 20 ever be substantially directly adjacent to the frame 12 or the wheels 14 of the walker 10, or spaced apart from the frame 12 or wheels 14 of the walker 10. For example, in one non-exclusive alternative embodiment, the curtain 20 can be substantially adjacent to both the upper portion 212U of the frame 12 and the wheels 14 of the walker 10 in either or both the first position and the second position, with the height adjustment of the curtain 20 being desired due to changes in the relative positioning of the frame 12 and/or the wheels 14, such as a height adjustment of the wheels 14 relative to the frame 12. In another non-exclusive alternative embodiment, the curtain 20 can be spaced apart from both the upper portion 212U of the frame 12 and the wheels 14 in either the first position or the second position.

It is further appreciated that the height of the curtain 20 relative to the frame 12 and/or the wheels 14 can be adjusted to any suitable positions. Stated in another manner, in some embodiments, the curtain 20 can be adjustable in height to any desired number of positions relative to the frame 12 and/or the wheels 14, so long as such height adjusted position can be effectively supported by the coupling members 22A.

In yet another advantage of the present invention, the coupling members 22A can be provided of sufficient length or size, and/or the coupling members 22A can be positioned at appropriate locations relative to the curtain body 20A and the frame 12, such that the coupling assembly 22 and/or the coupling members 22A can be used with frames 12 where the frame members 12A can have different circumferences. Stated in another manner, the coupling members 22A can be configured to accommodate different circumferences of the frame members 12A of the frame 12 at specific points where the coupling members 22A are attached to the frame 12. For example, for frame members 12A of the frame 12 having a smaller circumference, the coupling members 22A can be of such length that the coupling members can wrap further about the frame members 12A and/or can be coupled back onto the curtain body 20A at a lower point of the curtain body 20A. Conversely, for frame members 12A of the frame 12 having a larger circumference, the same coupling members 20A can wrap to a lesser degree about the frame members 12A and/or can be coupled back onto the curtain body at a higher point on the curtain body 20A, such as near and/or adjacent to an upper edge of the curtain body 20A. Thus, regardless of the actual circumference of the frame members 12A, the coupling assembly 22 and/or the coupling members 22A are still able to effectively couple the curtain 20 to the frame 12 of the walker 10.

As noted herein, in various embodiments, the walker 10 can be selectively movable between the active (open) configuration and the folded (closed) configuration, with the movement between the active configuration and the folded configuration being accomplished in any suitable manner. In yet another advantage of the present invention, in some such embodiments, the curtain 20 can remain coupled to the frame 12 while the walker 10 is moved between the active (open) configuration and the folded (closed) configuration.

Referring now to FIGS. 3A and 3B, FIG. 3A is a top perspective front view illustration of the rolling walker 10 and the curtain 20 illustrated in FIG. 1A, with the rolling walker 10 and the curtain 20 in the active configuration; and FIG. 3B is a top perspective front view illustration of the rolling walker 10 and the curtain 20 illustrated in FIG. 3A, with the rolling walker 10 and the curtain 20 in the folded configuration. As shown, the curtain 20 can remain coupled to the frame 12 of the walker 10, i.e. with the coupling assembly 22, when the walker 10 is in the active configuration and when the walker 10 is in the folded configuration. Moreover, the curtain 20 can remain coupled to the frame 12 of the walker 10, i.e. with the coupling assembly 22, during any movements of the walker 10 between the active configuration and the folded configuration. It is appreciated that the specific movements of the seat 18, the side sections 26 and the handlebars 16 for this embodiment during movement between the active configuration and the folded configuration have been described in detail herein above.

In another illustration of potential movement between the active configuration and the folded configuration, FIG. 4A is a top perspective front view illustration of another embodiment of the rolling walker 410 and the curtain 420, with the rolling walker 410 and the curtain 420 in the active configuration; and FIG. 4B is a top perspective front view illustration of the rolling walker 410 and the curtain 420 illustrated in FIG. 4A, with the rolling walker 410 and the curtain 420 in the folded configuration. In this embodiment, as shown, the curtain 420 can again remain coupled to the frame 412 of the walker 410, i.e. with the coupling assembly 422, when the walker 410 is in the active configuration and when the walker 410 is in the folded configuration. Moreover, the curtain 420 can remain coupled to the frame 412 of the walker 410, i.e. with the coupling assembly 422, during any movements of the walker 410 between the active configuration and the folded configuration. It is again appreciated that the specific movements of the seat 18 and the side sections 26 for this embodiment during movement between the active configuration and the folded configuration have been described in detail herein above.

Returning again to FIG. 1A, in yet another advantage of the present invention, in some embodiments, the curtain 20 and/or the coupling assembly 22 can include a strap portion 44 (which can be formed from leather, faux leather, vinyl, cut and loop, etc. in certain non-exclusive embodiments) that some of the coupling members 22A and the cover portion of the curtain 20 are attached to. As shown, in certain such embodiments, the strap portion 44 of the coupling assembly 22 can be positioned and/or configured to wrap around and couple the curtain to a portion of the back support 21.

In still yet another advantage of the present invention, in certain embodiments, the curtain 20 can function to control and/or restrict the positioning of the brake wires 32 of the braking system 28 incorporated into the walker 10 so that the brake wires 32 are inhibited from catching on external devices (such as door knobs, etc.).

FIG. 1B is a top perspective rear view illustration of the rolling walker 10 and the curtain 20 illustrated in FIG. 1A. More particularly, FIG. 1B again illustrates that the walker 10 can include (i) the walker frame 12, including the front frame section 24 and the side frame sections 26; (ii) the wheels 14; (iii) the handlebars 16; (iv) the seat 18, including the seating member 18A and the seat support members 18B; (v) the curtain 20, including the curtain body 20A; (vi) the coupling assembly 22; and (vi) the braking system 28.

FIG. 1C is a front elevation view illustration of the rolling walker 10 and the curtain 20 illustrated in FIG. 1A. In particular, FIG. 1C provides an alternative view of various components of the walker 10.

FIG. 1D is a rear elevation view illustration of the rolling walker 10 and the curtain 20 illustrated in FIG. 1A. In particular, FIG. 1D provides still another alternative view of various components of the walker 10.

FIG. 1E is a side elevation view illustration of the rolling walker 10 and the curtain 20 illustrated in FIG. 1A. In particular, FIG. 1E provides yet another alternative view of various components of the walker 10.

FIG. 1F is a top view illustration of the rolling walker 10 and the curtain 20 illustrated in FIG. 1A. In particular, FIG. 1F provides still yet another alternative view of various components of the walker 10.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

It is understood that although a number of different embodiments of the rolling walker 10 and/or the curtain 20 have been illustrated and described herein, one or more features of any one embodiment can be combined with one or more features of one or more of the other embodiments, provided that such combination satisfies the intent of the present invention.

While a number of exemplary aspects and embodiments of the rolling walker 10 and/or the curtain 20 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope, and no limitations are intended to the details of construction or design herein shown.

What is claimed is:

1. A curtain for use by a user with a rolling walker, the rolling walker including a walker frame having a front frame section and a pair of opposed side frame sections that are coupled to the front frame section, the curtain comprising:
a curtain body that is configured to wrap around the rolling walker so that at least 75% of each of the front frame section and the side frame sections are covered by the curtain body; and
a coupling assembly that is configured to couple the curtain body to the walker frame of the rolling walker.

2. The curtain of claim 1 wherein the curtain body is configured to wrap around the rolling walker so that at least 90% of each of the front frame section and the side frame sections are covered by the curtain body.

3. The curtain of claim 1 wherein the coupling assembly is configured to removably couple the curtain body to the walker frame of the rolling walker.

4. The curtain of claim 3 wherein the curtain body includes a first surface having a first design and an opposed second surface having a second design that is different than the first design; and wherein the curtain body is reversibly coupled to the walker frame so that in a first configuration the first surface faces in an outwardly direction away from the walker frame, and in a second configuration the second surface faces in an outwardly direction away from the walker frame.

5. The curtain of claim 1 wherein the walker frame includes a plurality of frame members; wherein the coupling assembly includes one or more coupling members that are configured to couple the curtain body to the walker frame of the rolling walker; and wherein each of the one or more coupling members have at least one of a length and a position that is sufficient to accommodate the frame members of the walker frame having different circumferences.

6. The curtain of claim 1 wherein the curtain body is formed as a unitary structure.

7. The curtain of claim 6 wherein the rolling walker is movable between an active configuration and a folded configuration; and wherein the coupling assembly is configured such that the curtain body remains coupled to the walker frame during movement of the rolling walker between the active configuration and the folded configuration.

8. The curtain of claim 1 further comprising one or more pockets that are coupled to the curtain body, and at least one of the one or more pockets includes a closing mechanism.

9. A curtain for use by a user with a rolling walker, the rolling walker including a walker frame having a plurality of frame members, and a plurality of wheels that are coupled to the walker frame, the curtain comprising:
a curtain body; and
a coupling assembly including one or more coupling members that are configured to couple the curtain body to the walker frame of the rolling walker, each of the one or more coupling members having at least one of a length and a position that is sufficient to accommodate the frame members of the walker frame having different circumferences.

10. The curtain of claim 9 wherein the walker frame includes a front frame section, and a pair of opposed side frame sections that are coupled to the front frame section; and wherein the curtain body is configured to wrap around the rolling walker so that at least 90% of each of the front frame section and the side frame sections are covered by the curtain body.

11. The curtain of claim 9 wherein the curtain body includes a first surface having a first design and an opposed second surface having a second design that is the same as the first design; and wherein the curtain body is reversibly coupled to the walker frame so that in a first configuration the first surface faces in an outwardly direction away from the walker frame, and in a second configuration the second surface faces in an outwardly direction away from the walker frame.

12. The curtain of claim 9 wherein the curtain body is formed as a unitary structure.

13. The curtain of claim 12 wherein the rolling walker is movable between an active configuration and a folded configuration; and wherein the coupling assembly is configured such that the curtain body remains coupled to the walker frame during movement of the rolling walker between the active configuration and the folded configuration.

14. The curtain of claim 9 further comprising one or more pockets that are coupled to the curtain body; and wherein at least one of the one or more pockets is transparent.

15. A curtain for use by a user with a rolling walker, the rolling walker including a walker frame, the rolling walker being movable between an active configuration and a folded configuration, the curtain comprising:
a curtain body; and
a coupling assembly that is configured to couple the curtain body to the walker frame of the rolling walker, the coupling assembly being configured such that the curtain body remains coupled to the walker frame during movement of the rolling walker between the active configuration and the folded configuration.

16. The curtain of claim 15 wherein the walker frame includes a front frame section, and a pair of opposed side frame sections that are coupled to the front frame section; and wherein the curtain body is configured to wrap around the rolling walker so that at least 90% of each of the front frame section and the side frame sections are covered by the curtain body.

17. The curtain of claim 15 wherein the curtain body includes a first surface having a first design and an opposed second surface having a second design that is different than the first design; and wherein the curtain body is reversibly coupled to the walker frame so that in a first configuration the first surface faces in an outwardly direction away from the walker frame, and in a second configuration the second surface faces in an outwardly direction away from the walker frame.

18. The curtain of claim 15 wherein the walker frame includes a plurality of frame members; wherein the coupling assembly includes one or more coupling members that are configured to couple the curtain body to the walker frame of the rolling walker; and wherein each of the one or more coupling members have at least one of a length and a position that is sufficient to accommodate the frame members of the walker frame having different circumferences.

19. The curtain of claim 15 wherein the curtain body is formed as a unitary structure.

20. The curtain of claim 9 further comprising one or more pockets that are coupled to the curtain body.
